(19) United States
(12) Patent Application Publication
(10) Pub. No.: US 2008/0203739 A1
(43) Pub. Date: Aug. 28, 2008

(54) Mixed type refrigerator with unit to keep doors closed

(75) Inventors: Jae Hoon Lim, Suwon-si (KR); Jae Myung Han, Gwangju (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/976,462

(22) Filed: Oct. 24, 2007

(30) Foreign Application Priority Data
Feb. 26, 2007 (KR) 10-2007-19202

(51) Int. Cl. E05B 15/02

(52) U.S. Cl. 292/340

(57) ABSTRACT

A refrigerator capable of preventing the loss of cool air caused by successive closing of both refrigerating compartment doors. The refrigerator includes a body having a storage compartment, a pair of first and second doors provided at opposite sides of the body to open or close the storage compartment together, and a closing keeping unit provided between each door and the body, to prevent the first door, which is in a closed state, from being opened by a predetermined external force generated as the second door is closed, while allowing the first door to be opened by an external force exceeding the predetermined external force, thereby efficiently preventing the loss of cool air due to the unintentional opening of the closed door.

### CROSS-REFERENCE TO RELATED APPLICATIONS

This application claims the benefit of Korean Patent Application No. 2007-0019202, filed on Feb. 26, 2007 in the Korean Intellectual Property Office, the disclosure of which is incorporated herein by reference.

### BACKGROUND

1. Field

The present invention relates to a refrigerator, and, more particularly, to a mixed type refrigerator having a unit to keep the refrigerator doors in a closed state.

2. Description of the Related Art

In general, a refrigerator is an apparatus to supply cool air, which is generated from an evaporator of a refrigeration cycle, into a storage compartment, for keeping various food reserves inside the storage compartment in a fresh state for a long time. The refrigerator includes a body forming the outer appearance of the refrigerator, a storage compartment defined in the body to have an opened front side, and a door coupled to a front side of the body to open or close the storage compartment.

Conventionally, domestic refrigerators may be classified, on the basis of the arrangement of a refrigerating compartment and a freezing compartment and the installation structure of doors, into a general type refrigerator, a side-by-side type refrigerator, a mixed type refrigerator, etc. In the most widely used general type refrigerator, a freezing compartment and a refrigerating compartment are arranged above and below each other, and also, a freezing compartment door and a refrigerating compartment door are arranged above and below each other.

In the side-by-side type refrigerator, a freezing compartment and a refrigerating compartment are arranged side by side, and a freezing compartment door and a refrigerating compartment door are arranged side by side. The freezing compartment includes an ice maker to make ice, and the freezing compartment door includes a dispenser to allow a user at the outside of the freezing compartment door to easily dispense ice made by the ice maker. The side-by-side type refrigerator is suitable for a high capacity refrigerator in which both a freezing compartment and a refrigerating compartment have a high capacity.

In the mixed type refrigerator, a freezing compartment is below and a refrigerating compartment is on top. The freezing compartment is opened or closed by a drawer type door, and the refrigerating compartment is opened or closed by a pair of refrigerating compartment doors. In this case, an ice maker is installed in the refrigerating compartment and a dispenser is installed to one of the refrigerating compartment doors. As compared to the side-by-side refrigerator in which the ice maker is installed in the freezing compartment, the mixed type refrigerator has an advantage of preventing water being supplied into the ice maker from being frozen.

One example of the mixed type refrigerator is disclosed in Korean Laid-open Patent Publication No. 2005-0117536. The conventional mixed type refrigerator, disclosed in the above publication, is configured such that a refrigerating compartment is provided in an upper section of a refrigerator body and a freezing compartment is provided in a lower section of the body. The refrigerating compartment is opened or closed by a pair of refrigerating compartment doors, and the freezing compartment is opened or closed by a drawer type door.

In the above described conventional mixed type refrigerator in which the single refrigerating chamber is closed by two doors, however, there is the problem in that, in the course of closing one of the doors in a state where the other door is in a closed state, the other door may be unintentionally opened by a pressure, thus causing the loss of cool air.

Further, to achieve an automatic closing function, the refrigerator door conventionally includes various elements such as a cam, a spring, etc. However, the spring has a gradual degradation in elastic force after a long time use. Therefore, to solve this problem, there is a need to change the spring periodically.

### SUMMARY

Accordingly, it is an aspect of the invention to provide a mixed type refrigerator having a side-by-side type refrigerating compartment, which can prevent the loss of cool air caused by successive closing of both refrigerating compartment doors.

Additional aspects and/or advantages of the invention will be set forth in part in the description which follows and, in part, will be apparent from the description, or may be learned by practice of the invention.

In accordance with the invention, the above and/or other aspects can be achieved by the provision of a refrigerator including a body having a storage compartment; a pair of doors provided at opposite sides of the body to open or close the storage compartment together; and a closing keeping unit provided between each door and the body, to prevent the associated door, which is in a closed state, from being opened by a predetermined external force generated as the other door is closed, while allowing the associated door to be opened by an external force exceeding the predetermined external force.

The closing keeping unit may include a cam member provided at the associated door; a lever provided at the body to be selectively caught by the cam member for keeping the associated door in a closed state, or to be released from the cam member for allowing the associated door to be opened; and an elastic member to elastically support the lever.

The body may include a hinge assembly to allow each door to be opened away from or closed to the body via a pivotal rotation thereof, and the lever may be disposed on the hinge assembly.

The hinge assembly may include a fixing portion and a reinforcing portion, and the door may be connected to the fixing portion, and the lever is installed on the reinforcing portion.

One end of the lever may be caught by the cam member, and the other end of the lever may be elastically supported on the hinge assembly by the elastic member.

The hinge assembly may include a plurality of fixing ends to regulate a tensile force of the elastic member.

The cam member may include a flat portion and a curved protruding portion, and one end of the lever may be located in a section between the flat portion and the apex of the curved protruding portion when the door is in a closed state.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a perspective view showing a refrigerator according to the present invention;

FIG. 2 is a perspective view showing a part of the refrigerator according to the present invention; and

FIGS. 3 to 5 are views illustrating the operation of a closing keeping unit included in the refrigerator according to the present invention.

### DETAILED DESCRIPTION OF THE EMBODIMENTS

Reference will now be made in detail to exemplary embodiments of the present invention, examples of which are illustrated in the accompanying drawings, wherein like reference numerals refer to like elements throughout. The embodiments are described below to explain the present invention by referring to the figures.

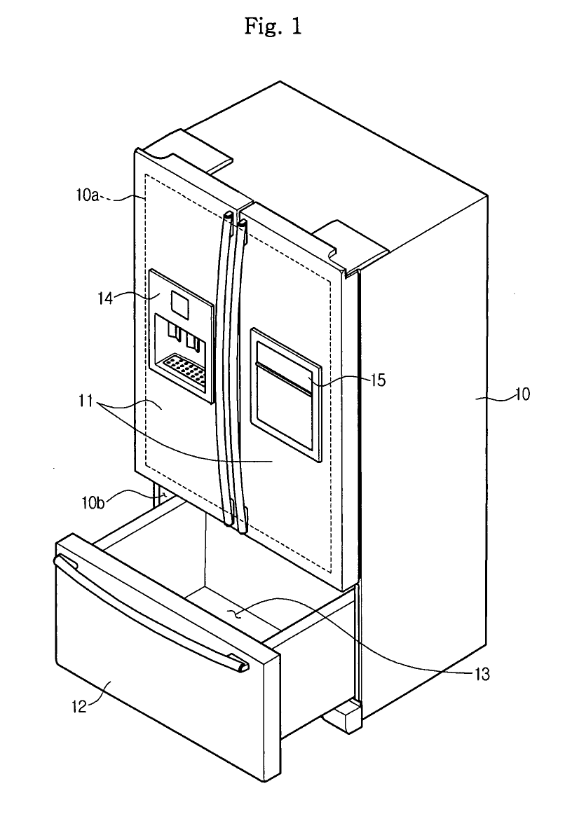

FIG. 1 is a perspective view showing a refrigerator according to the present invention. Referring to the drawing, the refrigerator includes a body 10 having a storage compartment therein. The storage compartment is divided into an upper storage compartment 10a serving as a refrigerating compartment, and a lower storage compartment 10b serving as a freezing compartment.

Doors 11 and 12 are installed at front sides of the respective storage compartments 10a and 10b, to selectively open or close the interior of the respective storage compartments 10a and 10b. Specifically, the refrigerating compartment 10a is provided with a pair of the doors 11 at left and right sides thereof, respectively. The doors 11 are opened away from or closed to the body 10 via a pivotal rotation thereof. The freezing compartment 10b is provided with the door 12 at a front side thereof. The door 12 is opened away from or closed to the body 10 via a forward sliding movement thereof. The door 12 of the freezing compartment 10b is a drawer type door, and slides together with an inner receiving member 13 upon an opening or closing operation thereof.

Although not shown, each of the pivotally rotatable opening/closing doors 11 includes a plurality of shelves installed at a rear surface thereof in multiple stages, to facilitate easy organization of food reserves. Similarly, a plurality of shelves and drawers or basket-shaped receiving members are installed in the refrigerating compartment 10a. The body 10 is installed, at the rear side of the refrigerating compartment 10a, with an evaporator, which constitutes a refrigeration cycle to generate cool air, for the supply of cool air into the upper storage compartment 10a. Also, a machine room is provided at the rear side of the freezing compartment 10b of the body 10, to receive a compressor and a condenser for compressing a refrigerant and condensing the compressed refrigerant. In FIG. 1, reference numeral 14 represents a dispenser, and reference numeral 15 represents a home-bar door.

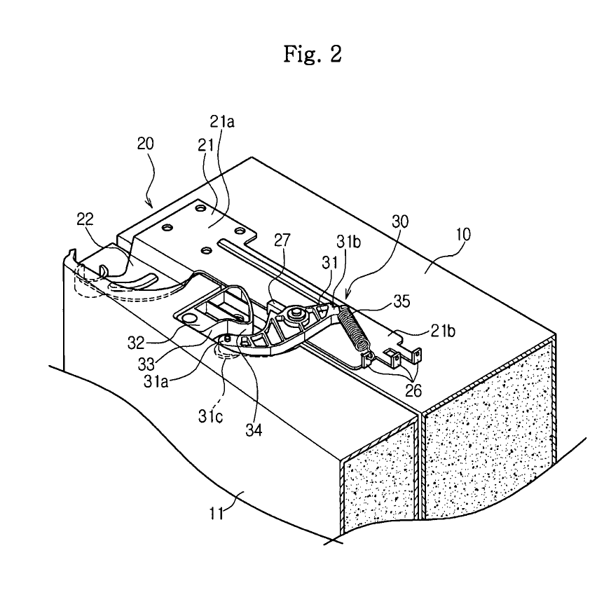

FIG. 2 is a perspective view showing a part of the refrigerator body and the door according to the present invention. As shown, the door 11 is coupled to a door hinge assembly 20, so as to be opened away from or closed to the body 10 via a pivotal rotation thereof. A pair of the hinge assemblies 20 are installed at upper and lower sides of the door 11, respectively.

Considering the illustrated upper hinge assembly 20 according to an embodiment of the present invention, a base bracket 21 of the hinge assembly 20 is installed to a front corner of the body 10, and an extended bracket 22 protrudes forward from the base bracket 21. A rotating shaft of the door 11 is coupled to the extended bracket 22.

In the mixed type refrigerator in which the single refrigerating chamber 10a is opened or closed by two doors, there is the problem in that any one of the doors, which is in a closed state, may be unintentionally opened by an external force caused as the other door is closed. To solve this problem, the present embodiment suggests a closing keeping unit 30, which is preferably installed to the hinge assembly 20.

The closing keeping unit 30 includes a pivotally rotatable lever 31, which is provided on the base bracket 21 of the hinge assembly 20 installed on the body 10, a cam member 32 provided on the door 11 to be selectively caught by a first end 31a of the lever 31, and an elastic member 35 to elastically support a second end 31b of the lever 31.

The base bracket 21 includes a fixing portion 21a and a reinforcing portion 21b extended from the fixing portion 21a parallel to a longitudinal direction of the door 11. The lever 31 is installed on the reinforcing portion 21b because, if the lever 31 is positioned close to the fixing portion 21a, the door 11 may be easily opened even by a low external force (i.e. a pressure generated upon closing of the other door) in the same manner as the prior art. Therefore, the lever 32 is preferably spaced apart from the fixing portion 21a by an appropriate distance on the basis of the capacity of the refrigerator.

The cam member 32 includes a flat portion 33 and a curved protruding portion 34 such that the first end 31a of the lever 31 is selectively caught by one of the portions 33 and 34 according to the opening or closing operation of the door. When the first end 31a of the lever 31 is caught by the flat portion 33, the door 11 is in a substantially closed state. When the first end 31a of the lever 31 is caught by the curved protruding portion 34, the door is in a slightly opened state.

The elastic member 35 is a conventionally used coil spring, and is provided between the second end 31b of the lever 31 and the reinforcing portion 21b of the base bracket 21. In an interval after the door 11 is opened but before the first end 31a of the lever 31 passes the flat portion 33 and the apex of the curved protruding portion 34, the elastic member 35 restricts the pivotal rotation of the lever 31, thereby allowing the door 11 to be automatically returned to a closed state thereof (auto-closing). Then, after the first end 31a of the lever 31 passes the apex of the curved protruding portion 34, the elastic member 35 applies an elastic force to the lever 31, thereby allowing the lever 31 to be returned to the flat portion 33 by passing the curved protruding portion 34 reversely. To assure efficient movements of the lever 31 and the cam member 32, a roller 31c is provided at the first end 31a of the lever 31.

Meanwhile, the reinforcing portion 21b of the base bracket 21 includes a plurality of fixing ends 26 to selectively support one end of the elastic member 35. The respective fixing ends 26 have different lengths from the second end 31b of the lever 31. Conventionally, if the elastic member has a degradation in elastic force by the repetitive opening and closing operations of the door 11, the elastic member should be changed with a new one. However, with the adoption of the different lengths of the fixing ends 26, the lifespan of the elastic member 35 can be prolonged by simply changing the fixing end 26, to which the end of the elastic member 35 is coupled.

In FIG. 2, reference numeral 27 represents a noise-proof stopper.

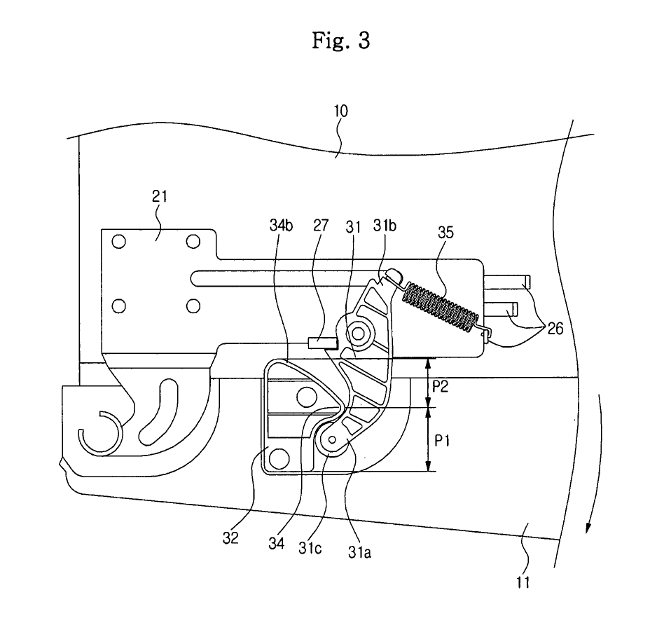

Now, the operation of the closing keeping unit 30 for the door having the above described configuration will be described with reference to FIGS. 3 to 5.

FIG. 3 illustrates the door 11 closed to the body 10. As shown, the first end 31a of the lever 31 is located in a first section P1 between the flat portion 33 of the cam member 32 and the apex of the curved protruding portion 34. Therefore, the door 11 can be stably kept in a closed state. Also, in a state wherein the door 11 is in the first section P1, the lever 31 cannot pass the curved protruding portion 34 by an external force even if the other door is closed. Therefore, the closed state of the door 11 can be kept with a high stability.

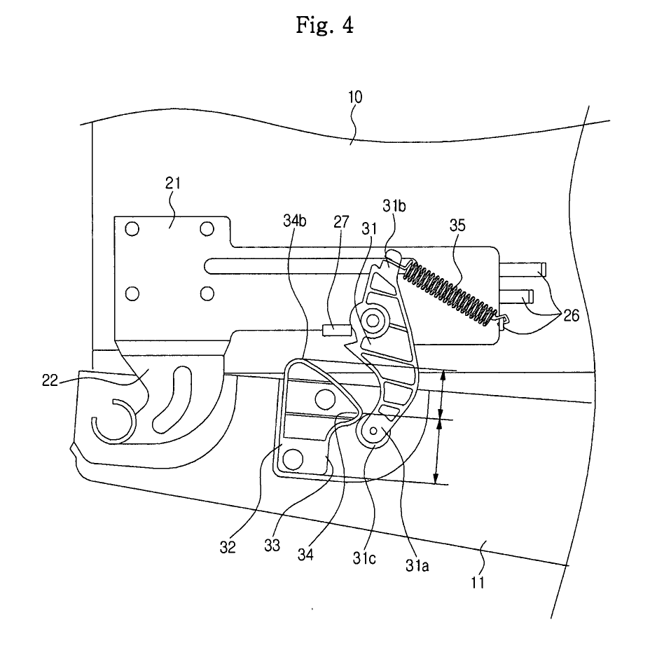

Subsequently, if the door 11 is opened by the user to the extent as shown in FIG. 4 (the first end 31a of the lever 31 is located in the first section P1), the lever 31 cannot pass the curved protruding portion 34 of the cam member 32 by the elastic force of the elastic member 35 provided at the second end 31b of the lever 31. Therefore, the door 11 can be elastically returned to the closed state thereof (i.e. to the state as shown in FIG. 1).

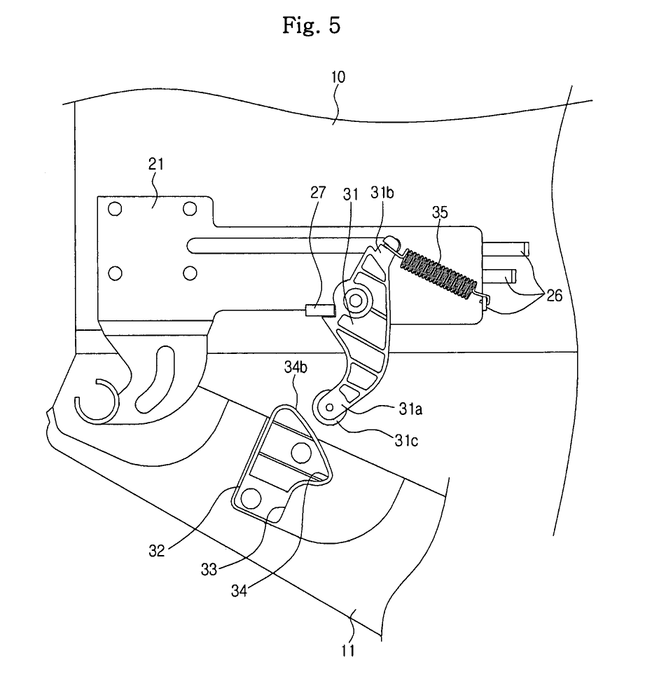

Meanwhile, if the first end 31a of the lever 31 passes the first section P1 and also, passes the overall second section P2 as shown in FIG. 5, the door 11 is kept in an opened state. In this case, the first end 31a of the lever 31 readies to come into contact with a specific portion of the curved protruding portion 34 located in the section P2 at the back of the apex of the curved protruding portion 34, under the influence of the restoration force of the elastic member 35.

Accordingly, if the user pushes the door 11 to close the door 11, the first end 31a of the lever 31 comes into contact with a rear surface 34b of the curved protruding portion 34 at the back of the apex and passes the second section P2 and the first section P1 in sequence, thereby causing the door 11 to be closed.

When the elastic force of the elastic member 35 is gradually degraded after a long time use, one end of the elastic member 35 is coupled to appropriately selected another fixing end 26, so as to keep the tensile force of the elastic member 35 at a constant level.

As apparent from the above description, the present invention provides a refrigerator in which a closing keeping unit is provided at each of a pair of doors provided at opposite sides of a single storage compartment to open or close the storage compartment, thereby efficiently preventing one door, which is in a closed state, from being unintentionally opened by an external force generated as the other door is closed.

Further, in the refrigerator according to the present invention, a hinge assembly includes a plurality of fixing ends to regulate the tensile force of an elastic member included in the closing keeping unit. This has the effect of extending the lifespan of the elastic member, thereby eliminating the need for a frequent change of the elastic member.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A refrigerator comprising:
a body having a storage compartment;
a pair of doors provided at opposite sides of the body to open or close the storage compartment together; and
a closing keeping unit provided between each door and the body, to prevent the associated door, which is in a closed state, from being opened by a predetermined external force generated as the other door is closed, while allowing the associated door to be opened by an external force exceeding the predetermined external force.

2. The refrigerator according to claim 1, wherein the closing keeping unit comprises:
a cam member provided at the associated door;
a lever provided at the body to be selectively caught by the cam member for keeping the associated door in a closed state, or to be released from the cam member for allowing the associated door to be opened; and
an elastic member to elastically support the lever.

3. The refrigerator according to claim 2, wherein:
the body comprises a hinge assembly to allow each door to be opened away from or closed to the body via a pivotal rotation thereof; and
the lever is disposed on the hinge assembly.

4. The refrigerator according to claim 3, wherein:
the hinge assembly comprises a fixing portion and a reinforcing portion; and
the door is connected to the fixing portion, and the lever is installed on the reinforcing portion.

5. The refrigerator according to claim 2, wherein:
one end of the lever is caught by the cam member; and
the other end of the lever is elastically supported on the hinge assembly by the elastic member.

6. The refrigerator according to claim 3, wherein the hinge assembly comprises a plurality of fixing ends to regulate a tensile force of the elastic member.

7. The refrigerator according to claim 2, wherein:
the cam member comprises a flat portion and a curved protruding portion; and
one end of the lever is located in a section between the flat portion and the apex of the curved protruding portion when the door is in a closed state.

8. The refrigerator according to claim 6, wherein each of the plurality of fixing ends is positioned at differing lengths from an end of the lever.

9. The refrigerator according to claim 5, further comprising a roller attached to the one end of the lever caught by the cam member.
